(19) United States
(12) Patent Application Publication
(10) Pub. No.: US 2014/0185990 A1
(43) Pub. Date: Jul. 3, 2014

(54) LENSED FERRULE ASSEMBLY WITH THERMAL EXPANSION COMPENSATION

(71) Applicants: Malcolm H. Hodge, Chicago, IL (US); Wenzong Chen, Naperville, IL (US); Dean Richardson, Wilmette, IL (US); Scot A. Ernst, Plainfield, IL (US); Thomas D. Schiltz, Naperville, IL (US); Thomas R. Marrapode, Naperville (IL)

(72) Inventors: Malcolm H. Hodge, Chicago, IL (US); Wenzong Chen, Naperville, IL (US); Dean Richardson, Wilmette, IL (US); Scot A. Ernst, Plainfield, IL (US); Thomas D. Schiltz, Naperville, IL (US); Thomas R. Marrapode, Naperville (IL)

(73) Assignee: Molex Incorporated, Lisle, IL (US)

(21) Appl. No.: 14/123,543

(22) PCT Filed: Jun. 14, 2012
(86) PCT No.: PCT/US2012/042432

§ 371 Date: Feb. 28, 2014

Related U.S. Application Data
(60) Provisional application No. 61/496,715, filed on Jun. 14, 2011.

(51) Int. Cl. G02B 6/32

(52) U.S. Cl. CPC G02B 6/32
USPC 385/79

(57) ABSTRACT

An optical fiber assembly includes a ferrule body with a plurality of optical fibers. An end face of each optical fiber extends past the front face of the ferrule body. A beam expanding element is generally adjacent the front face of the ferrule body and has a lens array aligned with the optical fibers. An index matched resilient medium engages the rearwardly facing surface of the beam expanding element and the end faces of the optical fibers.

### REFERENCE To RELATED APPLICATIONS

The Present Disclosure claims priority to prior-filed U.S. Provisional Patent Application No. 61/496,715, entitled “Paroli-Type Ferrule Assembly,” filed on 14 Jun. 2011 with the United States Patent And Trademark Office. The content of the aforementioned Patent Application is incorporated in its entirety herein.

### BACKGROUND OF THE PRESENT DISCLOSURE

The Present Disclosure relates generally to optical fiber ferrule assemblies and, more particularly, to a multi-fiber ferrule assembly with an adjacent lens structure having a structure for thermal expansion compensation.

Systems for interconnecting optical fibers typically utilize mating ferrule assemblies to facilitate handling and accurate positioning of the fibers. The optical fibers are secured within a ferrule body with an end surface of each fiber being positioned generally flush with or slightly protruding from an end face of the ferrule body. The end surfaces or faces of the fibers are often polished to desired finish. When complementary ferrules assemblies are mated, each optical fiber of one ferrule assembly is aligned with a mating optical fiber of the other ferrule assembly.

In some applications, the end faces of the mating optical fibers physically contact one another in order to effect signal transmission between the mating optical fiber pair. In such applications, various factors may reduce the efficiency of the light transmission between the optical fiber pair such as irregularities, burrs or scratches in the fiber end faces, misalignment of the fibers as well as dust or debris between the fibers at the mating interface.

Due to the small optical path relative to the size of any foreign objects such as dust or debris, any such foreign objects will likely interfere with the transmission of light. Expanded beam connectors expand the width of the optical beam and transmit the beam over an air gap between the connectors. By expanding the beam, the relative size difference between the dust or debris and the beam is increased which thus reduces the impact of any dust or debris as well as any misalignment on the efficiency of the light transmission. As a result, expanded beam optical fiber connectors are often used in dirty and high vibration environments.

Expanded beam connectors include a lens mounted adjacent an end face of each fiber. Two types of lenses are commonly used—collimating and cross-focusing. A collimating lens receives the light from the fiber and expands the beam to a relatively large diameter. When using a collimating lens, a second lens and ferrule assembly is similarly configured with the lens positioned adjacent the end face of the second fiber for receiving the expanded beam, and refocuses the beam at the end face of the second fiber. A cross-focusing lens receives the light from the fiber, expands it to a relatively large diameter and then focuses the light from the relatively large diameter at a specific focal point. With cross-focusing lenses, the lens and ferrule assembly may be mated with either another lens and ferrule assembly having a cross-focusing lens or with a non-lensed ferrule assembly as is known in the art.

In one design, the optical fibers of an expanded beam multi-fiber ferrule assembly extend through the ferrule body and into contact with the optical fiber lens plate or assembly. The quality of the contact between the optical fibers and the lens plate is one of the factors that impacts the performance of the ferrule assembly. The optical fibers may be formed of a different material than the ferrule body and the lens block. Differences in coefficients of thermal expansion of the components may result in inconsistent contact between the optical fibers and the lens plate. Such inconsistent contact may result in the degradation of the quality of light transmission of the ferrule assembly. It is desirable to provide a multi-fiber lensed ferrule assembly that compensates for differences in thermal expansion between components of the assembly.

### SUMMARY OF THE PRESENT DISCLOSURE

In one aspect, an optical fiber assembly includes a plurality of generally parallel optical fibers, a ferrule body, a beam expanding element and an index matched medium. Each optical fiber has an end face and is positioned in the ferrule body. The ferrule body has a front face and the end face of each optical fiber is positioned generally adjacent and extends past the front face of the ferrule body. The beam expanding element is generally adjacent the front face of the ferrule body and has a lens array and a rearwardly facing surface. The lens array is aligned with the optical fibers and is spaced from the optical fibers by a predetermined distance. The index matched resilient medium engages the rearwardly facing surface of the beam expanding element and the end faces of the optical fibers.

In another aspect, an optical fiber assembly includes a plurality of generally parallel optical fibers with each optical fiber having an optical fiber index of refraction and an end face. The end faces of the optical fibers are generally aligned in a common plane. A ferrule body has the plurality of optical fibers positioned therein and a front face. A beam expanding element is generally adjacent the front face of the ferrule body. The beam expanding element has a beam expanding element index of refraction and a lens array aligned with the optical fibers of ferrule. The lens array is spaced from the optical fibers by a predetermined distance. A resilient medium engages the end faces of the optical fibers and the beam expanding element and has a resilient medium index of refraction. The optical fiber index of refraction, the beam expanding element index of refraction and the resilient medium index of refraction are each approximately equal.

In still another aspect, an optical fiber assembly includes a plurality of generally parallel optical fibers with each optical fiber having an end face. A ferrule body has the plurality of optical fibers positioned therein and includes a front face. The end face of each optical fiber is positioned generally adjacent and extends past the front face of the ferrule body. A beam expanding element is generally adjacent the front face of the ferrule body and includes a front face and a rear face. The front face includes a lens array aligned with the optical fibers of ferrule with the lens array being spaced from the optical fibers by a predetermined distance. The rear face of the beam expanding element is positioned generally adjacent the front face of the ferrule body. The rear face of the beam expanding element has a recess extending towards the front face of the beam expanding element and the recess has a rearwardly facing surface. An index matched resilient medium is within the recess. The resilient medium engages the rearwardly facing forward surface of the recess and the end faces of the optical fibers.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of an embodiment of a terminated ferrule assembly;

FIG. 2 is a partially exploded perspective view of the ferrule assembly of FIG. 1 together with an assembly fixture;

FIG. 3 is a perspective view similar to FIG. 2, but taken from the rear direction;

FIG. 4 is a section taken generally along Line 4-4 of FIG. 1; and

FIG. 5 is an enlarged view of the circled portion of FIG. 4.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

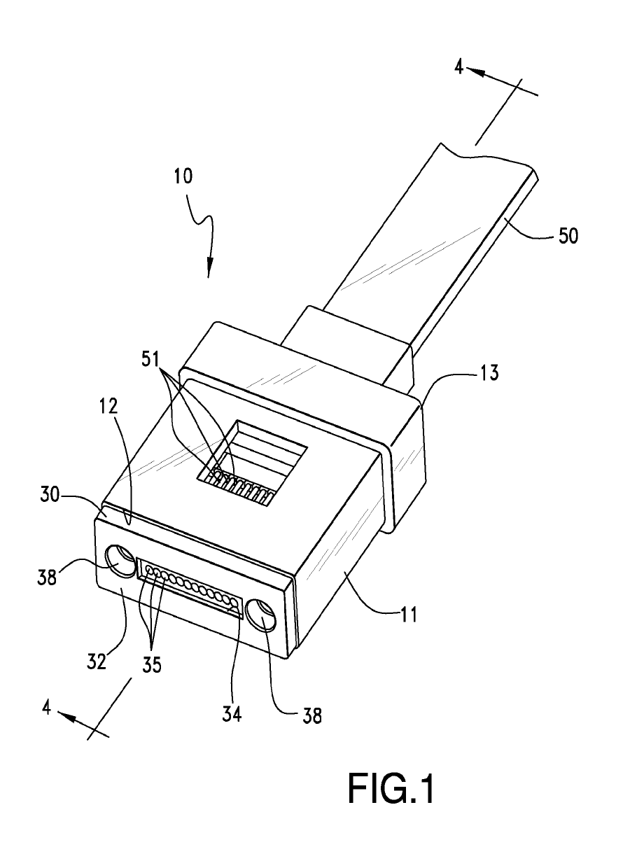

Referring to FIG. 1, a multi-fiber MT type lensed ferrule assembly 10 is illustrated. The ferrule assembly 10 includes a ferrule body 11 having a plurality of optical fibers 51 of a multi-fiber cable 50 therein. A light or beam expanding element such as lens plate 30 is fixed to the ferrule body 11. As depicted, ferrule assembly 10 includes one row of twelve optical fibers 51 although the ferrule assembly may be configured to receive greater or fewer optical fibers if desired.

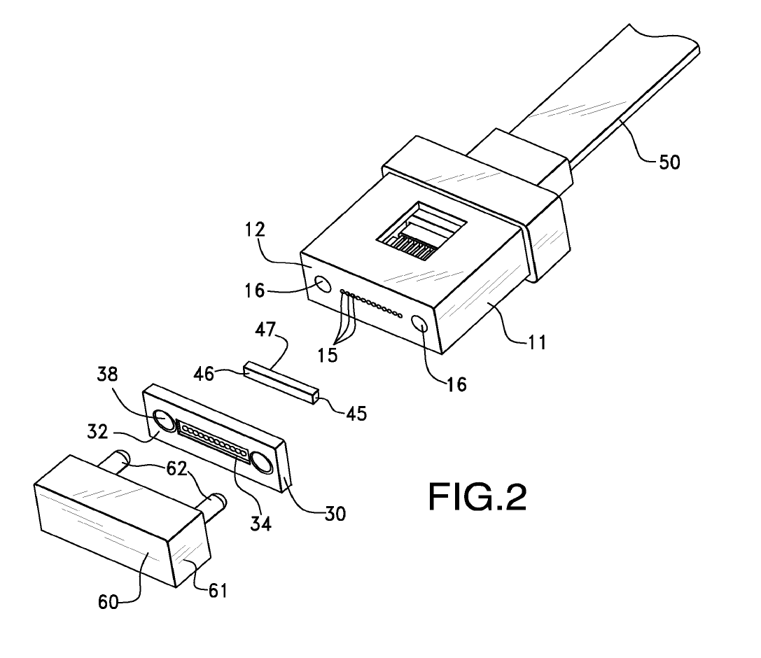

The ferrule body 11 is generally rectangular and has a generally flat front face 12 and a generally flat rear face 13. As depicted in FIG. 2, ferrule body 11 includes one row of twelve generally cylindrical optical fiber receiving holes or bores 15 that extend through the ferrule body 11 to the front face 12. In addition, ferrule body 11 may include a pair of alignment holes or receptacles 16 positioned on opposite sides of the array of fiber receiving holes 15.

Alignment holes 16 are generally cylindrical and extend between front face 12 and rear face 13. In some embodiments, the holes 16 may not extend all of the way to rear face 13, may not have a uniform cross-section (such as the cylinder depicted) but rather may be tapered or stepped as disclosed in U.S. Pat. No. 7,527,436, or may have a uniform, non-circular cross-section such as a hexagonal cross-section. The alignment holes 16 are configured to receive a post (not shown) therein to facilitate alignment when mating a pair of assemblies. In the depicted MT ferrule body 11, each alignment hole 16 has a diameter of approximately 700 microns. Alignment holes of other diameters could be used if desired.

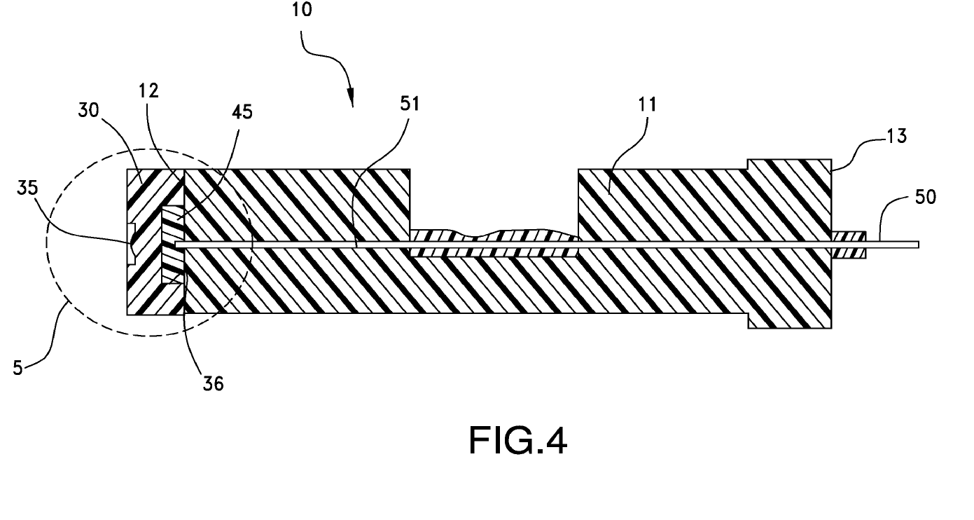

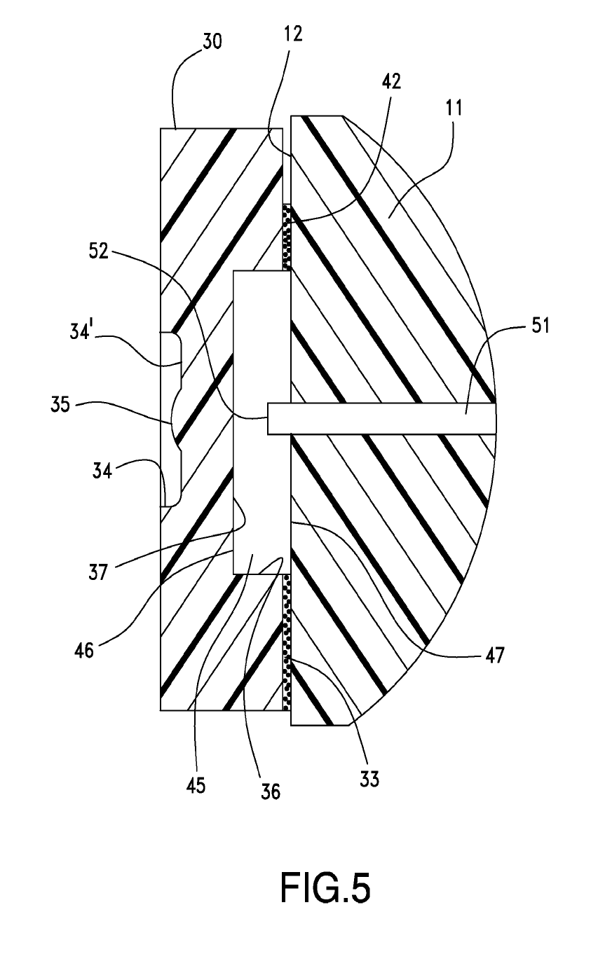

Ferrule body 11 may be formed of a resin capable of being injection molded such as polyphenylene sulphide or polyetherimide and may include an additive such as silica (SiO₂) to increase the strength and stability of the resin. Other materials may be used if desired. One of the optical fibers 51 of multi-fiber cable 50 is positioned within each fiber receiving hole 15 and extends past the front face 12 of the ferrule body 11. The end faces 52 of the optical fibers 51 may extend past the front face 12 of the ferrule body 11 by as little as 3-4 microns or a greater distance such as 20 microns. In some applications, it may be possible for the end faces 52 to extend past the front face 12 of the ferrule body 11 by as much as 50 microns. The distance that the end faces 52 extend past the front face 12 of the ferrule body 11 is exaggerated in FIGS. 4-5 for clarity. In one example, the optical fiber 51 may have a diameter of approximately 125 microns. Optical fibers 51 may be secured within the fiber receiving holes 15 by an adhesive such as epoxy. The end faces 52 of the optical fibers 51 adjacent the front face 12 may be polished or otherwise processed to a desired finish.

Lens plate 30 is generally rectangular and has a front face 32 and a rear face 33. Lens plate 30 may be formed of an optical grade resin that is capable of being injection molded with a refractive index closely matching that of the optical fibers 51. In other words, optical fibers 51 have an optical fiber index of refraction and the lens plate 30 has a lens plate index of refraction.

It is desirable to choose material so as to set the optical fiber index of refraction and the lens plate index of refraction as approximately equal.

A recess 34 is centrally located in the front face 32 and includes a plurality of lens elements 35. One lens element 35 is aligned with the end face 52 of each optical fiber 51 located in its respective optical fiber receiving hole 15 in the ferrule body 11. In an expanded beam connector, two common types of lens elements are collimating and cross-focusing. In the depicted embodiment, the lens elements 35 are of the cross-focusing type and include a convex shape (FIG. 5) projecting from the bottom 34′ of recess 34 towards front face 32 of lens plate 30. The rear face 33 of lens plate 30 has a generally rectangular receptacle or recess 36 therein. The recess 36 is generally aligned with the array of lens elements 35 and thus is aligned with each of the optical fibers 51 when the lens plate 30 is secured to the ferrule body 11. Recess 36 has a rearwardly facing surface 37 generally parallel to and spaced forwardly from the rear face 33 of the lens plate 30. The depth of the recess 36 defines the distance that the rearwardly facing surface 37 is spaced from the rear face 33.

Lens plate 30 also includes a pair of cylindrical guide holes or receptacles 38 that are configured to be aligned with the alignment holes 16 of ferrule body 11. Each guide hole 38 may be configured to have a diameter that matches or is larger than that of alignment hole 16 of ferrule body 11. Lens plate 30 may have a pair of circular spacers or pedestals 40 projecting from rear face 33 with one surrounding each guide hole 38. The length of the spacers 40 may be chosen so as to define a consistent and predetermined distance or gap between the front face 12 of ferrule body 11 and the rear face 33 of lens plate 30.

A resilient, index-matched medium or insert 45 having a forward end surface 46 and a rearward end surface 47 is positioned within the recess 36 in lens plate 30. The forward end surface 46 is compressed against the rearwardly facing surface 37 of recess 36 (FIG. 5). The rearward end surface 47 is compressed against the end faces 52 of the optical fibers 51. The rearward end surface 47 may also be compressed against the front face 12 of ferrule body 11 depending upon the distance that the optical fibers 51 extend past the front face 12 and the thickness of the resilient insert 45 and other characteristics of the resilient insert. The resilient insert 45 is thus generally aligned with and compressed between the array of lens elements 35 and each of the optical fibers 51 when the lens plate 30 is secured to the ferrule body 11. Resilient insert 45 is depicted as being generally rectangular to match the shape of recess 36.

Recess 36 and resilient insert 45 may have other shapes if desired and may not have matching shapes in all instances.

Although depicted in FIGS. 2-5 as being relatively thick for purposes of the depiction, the resilient insert 45 may have a wide variety of thicknesses. More specifically, the depth of recess 36 and the thickness of resilient insert 45 may be chosen as desired so long as the resiliency of the insert 45 compensates for the differences in thermal expansion between the ferrule body 11 and the lens plate 30 relative to the optical fibers 51. As an example, if the ferrule body 11 and the lens plate 30 are formed of some type of polymer and the optical fibers are formed of a glass material such as silica, the components of the ferrule assembly 10 are likely to have different coefficients of thermal expansion. As the temperature of the operating environment of the ferrule assembly 10 changes, the relative difference in thermal expansion between the optical fibers 51 and the other components of the assembly may be as much as approximately 3-4 microns. It is believed that a resilient member 45 of at least 100 microns thick in one embodiment and at least 75 microns thick in another embodiment will compensate for such differences in thermal expansion. A resilient member 45 of other thicknesses may be used depending on the performance characteristics of resilient member.

The resilient insert 45 may be formed of a resilient material having an index of refraction approximately equal to those of the lens plate 30 and the optical fibers 51. In other words, the optical fiber index of refraction, the lens plate index of refraction and the resilient insert index of refraction are desirably approximately equal. By choosing materials that have approximately equal indices of refraction, transmission losses due to differences between the indices of refraction are minimized. In one example, the resilient insert 51 may be formed of silicone but, in some applications, other materials such as urethane may also be used.

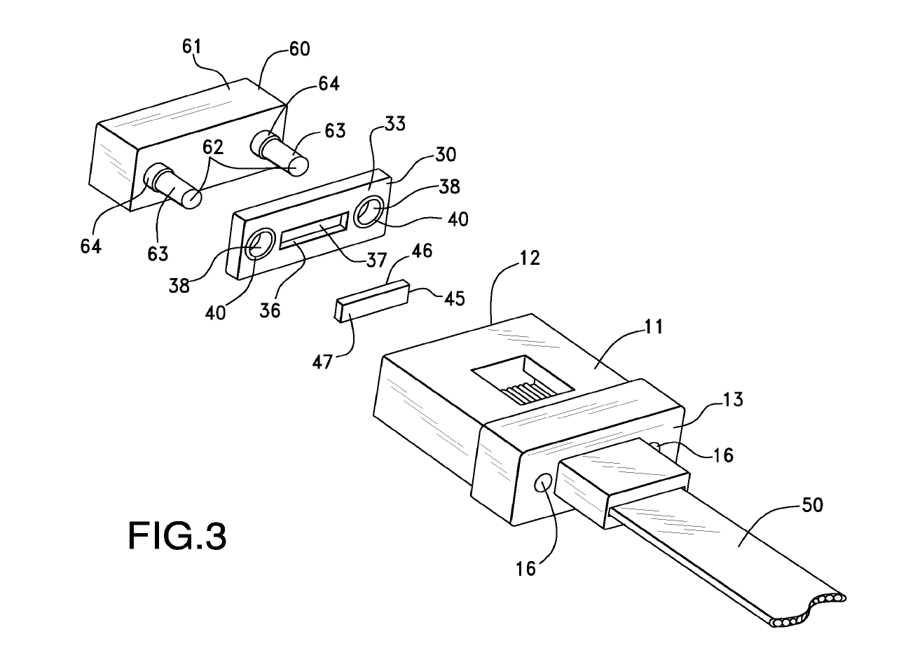

Referring to FIGS. 2-3, a process in which the lens plate 30 is mounted on ferrule body 11 is shown. The ferrule body 11 is depicted with a plurality of optical fibers 51 of multi-fiber cable 50 secured within fiber receiving holes 15. A length of each optical fiber 51 extends beyond the front face 12 of ferrule body 11 although substantially less than that depicted in FIGS. 4-5. The end faces 52 of the optical fibers 51 may be polished or otherwise finished as desired. Lens plate 30 is spaced from ferrule body 11 with the guide holes 38 in lens plate 30 aligned with the alignment holes 16 in the front face 12 of ferrule body 11. Resilient insert 45 is depicted in FIGS. 2-3 as being a separate component to be assembled between the ferrule body 11 and the lens plate 30. In some instances, the resilient insert 45 may be inserted into lens plate 30 as part of a pre-assembly process to simplify the manufacturing process.

An assembly fixture 60 may be used for aligning the ferrule body 11 and lens plate 30. More specifically, fixture 60 has a generally rectangular body 61 and a pair of spaced apart guide posts 62 that pass through the guide holes 38 of lens plate 30 and into alignment holes 16 of ferrule body 11 to align the ferrule body with the lens plate during the manufacturing process. Each guide post 62 may include an enlarged first section 63 adjacent body 61 that has a diameter generally configured to match the diameter of guide hole 38 in lens plate 30. Each guide post may further include a second section 64 spaced from body 61 that has a diameter generally configured to match the diameter of the alignment holes 16 in ferrule body 11 that is smaller than the diameter of the first section 63.

During assembly, the lens plate 30 with the resilient insert 45 in recess 36 are slid onto the guide posts 62 of fixture 60 with the ends of the guide posts extending through the guide holes 38 past the rear face 33 of lens plate 30. Adhesive 42 may be applied to the rear face 33 of lens plate 30 and the guide posts 62 slid into the alignment holes 16 in the front face 12 of ferrule body 11. The lens plate 30 and resilient insert 45 are moved relatively towards the ferrule body 11 with the optical fibers 51 secured therein. As the lens plate 30 reaches the ferrule body 11, the end faces 52 of the optical fibers 51 will engage and compress the resilient insert 45. The lens plate 30 and the resilient insert 45 are secured in against the ferrule body 11 and the optical fibers 51, respectively, while the adhesive is fixed or set.

While a preferred embodiment of the Present Disclosure is shown and described, it is envisioned that those skilled in the art may devise various modifications without departing from the spirit and scope of the foregoing Description and the appended Claims.

What is claimed is:

1. An optical fiber assembly comprising:
a plurality of generally parallel optical fibers, each optical fiber having an end face;
a ferrule body having the plurality of optical fibers positioned therein, the ferrule body having a front face, the end face of each optical fiber being positioned generally adjacent and extending past the front face of the ferrule body;
a beam expanding element generally adjacent the front face of the ferrule body, the beam expanding element having a lens array and a rearwardly facing surface, the lens array being aligned with the optical fibers and being spaced from the optical fibers by a predetermined distance; and
an index matched resilient medium, the resilient medium engaging the rearwardly facing surface of the beam expanding element and the end faces of the optical fibers.

2. The optical fiber assembly of claim 1, wherein the rearwardly facing surface of the beam expanding element is positioned generally adjacent but spaced from the front face of the ferrule body, and the beam expanding element has a recess extending towards the lens array, the index matched medium being positioned within the recess.

3. The optical fiber assembly of claim 2, wherein the rearwardly facing surface is within the recess, and a forward end surface of the resilient medium is compressed against the rearwardly facing surface of the recess and a rearward end surface of the resilient medium is compressed against the end face of each optical fiber.

4. The optical fiber assembly of claim 1, wherein the resilient medium is formed of a silicone material.

5. The optical fiber assembly of claim 1, wherein the end faces of the optical fibers are generally aligned in a common plane.

6. The optical fiber assembly of claim 1, wherein the optical fibers, the beam expanding element, and the index matched resilient medium each have an index of refraction and the index of refraction for each is approximately equal.

7. The optical fiber assembly of claim 1, wherein the beam expanding element is a generally rectangular lens plate having a plurality of lenses, each lens being aligned with one of the optical fibers.

8. The optical fiber assembly of claim 1, wherein the optical fibers are arranged in at least one generally linear array.

9. The optical fiber assembly of claim 1, wherein the resilient medium is at least approximately 75 microns thick.

10. An optical fiber assembly comprising:
a plurality of generally parallel optical fibers, each optical fiber having an optical fiber index of refraction and an end face, the end faces of the optical fibers being generally aligned in a common plane;
a ferrule body having the plurality of optical fibers positioned therein, the ferrule body having a front face;
a beam expanding element generally adjacent the front face of the ferrule body, the beam expanding element having a beam expanding element index of refraction and a lens array aligned with the optical fibers of ferrule, the lens array being spaced from the optical fibers by a predetermined distance; and
a resilient medium engaging the end faces of the optical fibers and the beam expanding element and having a resilient medium index of refraction;
wherein the optical fiber index of refraction, the beam expanding element index of refraction and the resilient medium index of refraction being approximately equal.

11. The optical fiber assembly of claim 10, wherein one of the ferrule body and the beam expanding element have a recess, the resilient medium being positioned in the recess.

12. The optical fiber assembly of claim 10, wherein the beam expanding element has a recess with the resilient medium positioned in the recess, the recess including a rearwardly facing surface, and a forward end surface of the resilient medium is compressed against the rearwardly facing surface of the recess and a rearward end surface of the resilient medium is compressed against the end face of each optical fiber.

13. The optical fiber assembly of claim 10, wherein the optical fibers deform the resilient medium.

14. The optical fiber assembly of claim 10, wherein the resilient medium is formed of a silicone material.

15. The optical fiber assembly of claim 10, wherein the resilient medium is at least approximately 75 microns thick.

16. The optical fiber assembly of claim 10, wherein the beam expanding element is a generally rectangular lens plate having a plurality of lenses, each lens being aligned with one of the optical fibers.

17. The optical fiber assembly of claim 10, wherein the optical fibers are arranged in at least one generally linear array, and the resilient medium extends along the linear array of optical fibers.

18. An optical fiber assembly comprising:
a plurality of generally parallel optical fibers, each optical fiber having an end face;
a ferrule body having the plurality of optical fibers positioned therein, the ferrule body having a front face, the end face of each optical fiber being positioned generally adjacent and extending past the front face of the ferrule body;
a beam expanding element generally adjacent the front face of the ferrule body, the beam expanding element having a front face and a rear face, the front face including a lens array aligned with the optical fibers of ferrule, the lens array being spaced from the optical fibers by a predetermined distance, the rear face of the beam expanding element being positioned generally adjacent the front face of the ferrule body, the rear face of the beam expanding element having a recess extending towards the front face of the beam expanding element, the recess having a rearwardly facing surface; and
an index matched resilient medium within the recess, the resilient medium engaging the rearwardly facing forward surface of the recess and the end faces of the optical fibers.

19. The optical fiber assembly of claim 18, wherein the optical fibers, the beam expanding element, and the index matched resilient medium each have an index of refraction and the index of refraction for each is approximately equal.

20. The optical fiber assembly of claim 18, wherein the resilient medium is at least approximately 75 microns thick.
